(19) United States
(12) Patent Application Publication
(10) Pub. No.: US 2013/0283155 A1
(43) Pub. Date: Oct. 24, 2013

(54) SYSTEM AND METHOD OF DISPLAYING AN OVERVIEW PAGE FOR A NUMBER OF COMPONENTS

(71) Applicant: BERNARD WASSERMAN, Thornhill (CA)

(72) Inventor: BERNARD WASSERMAN, Thornhill (CA)

(21) Appl. No.: 13/454,173

(22) Filed: Apr. 24, 2012

(51) Int. Cl. G06F 17/00

(52) U.S. Cl. 715/256; 715/273

(57) ABSTRACT

A system includes a number of components; and a processor comprising a display, a program and a text file. The processor is structured to cause the display to display an initial overview display page operatively associated with the number of components. The processor is further structured to execute the program and cause the display to display a subsequent overview display page operatively associated with the number of components based upon the text file.

### BACKGROUND

1. Field

The disclosed concept pertains generally to systems and, more particularly, to systems, such as, for example and without limitation, motor control center (MCC) systems that include MCC cells, a data concentrator and an overview display. The disclosed concept also pertains to methods of displaying overview displays for such systems.

2. Background Information

Known motor starters, load monitoring relays and other components of motor control centers (MCCs) are configured by manually selecting parameters (e.g., manually from a component user interface or manually from a user interface of a processor or other component configuration device) for each component type.

Known MCC human machine interface (HMI) programs, such as for displaying graphic screens, such as overview pages, are generally compiled code. Any changes require this code to be modified through a corresponding development environment. This involves programmed software and a software programmer to implement changes and/or additions to the programmed software. In order to do this, a skilled software programmer makes the software changes, re-compiles the code, and installs the code onto the corresponding MCC device. Since changing the code requires replacing the prior code, the MCC device needs to stop running the old code and, in turn, run the new code after it is installed. Hence, it is believed that this requires both a skilled software programmer and a system reboot.

There is room for improvement in systems and methods of displaying overview pages.

### SUMMARY

These needs and others are met by embodiments of the disclosed concept in which additions or changes to, for example, an MCC overview page can be made without the need for a system reboot and without the need of a software programmer.

In accordance with one aspect of the disclosed concept, a system comprises: a number of components; and a processor comprising a display, a program and a text file, wherein the processor is structured to cause the display to display an initial overview display page operatively associated with the number of components, and wherein the processor is further structured to execute the program and cause the display to display a subsequent overview display page operatively associated with the number of components based upon the text file.

The processor may further comprise a user interface; and the processor may be structured to read the text file by the program in response to the user interface or on power up of the processor, and cause the display to display the subsequent overview display page based upon the text file.

The subsequent overview display page may include a plurality of displayed elements; each of the displayed elements includes a visibility, a location and a size; and the text file defines the visibility, the location and the size of each of the displayed elements.

As another aspect of the disclosed concept, a method of display for a number of components of a system comprises: displaying an initial overview display page operatively associated with the number of components; and executing a program by a processor and responsively displaying a subsequent overview display page operatively associated with the number of components based upon a text file.

The method may further comprise displaying a plurality of elements with the subsequent overview display page; including a visibility, a location and a size with each of the displayed elements; and defining the visibility, the location and the size of each of the displayed elements from the text file.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of a system including a number of databases, a number of motor control center (MCC) cells and a data concentrator in accordance with embodiments of the disclosed concept.

FIG. 2 is a block diagram showing an initial data concentrator overview default display page, a data concentrator program, a text file, and a subsequent data concentrator overview display page that is displayed based upon the uploaded text file in accordance with an embodiment of the disclosed concept.

FIGS. 3A and 3B form a diagram showing how a text file corresponds to an overview display by defining visibility, location and size of various display elements in accordance with an embodiment of the disclosed concept.

FIG. 4 is a flowchart of logic implemented by the data concentrator program of FIG. 2.

FIG. 5 is an example data concentrator overview display showing upper and lower banners above and below, respectively, various display elements.

FIG. 6 shows a user interface of a text editor in accordance with an embodiment of the disclosed concept.

### DESCRIPTION OF THE PREFERRED EMBODIMENTS

As employed herein, the term “number” shall mean one or an integer greater than one (i. e. , a plurality).

As employed herein, the term “processor” shall mean a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; a data concentrator; a programmable logic controller (PLC); or any suitable processing device or apparatus.

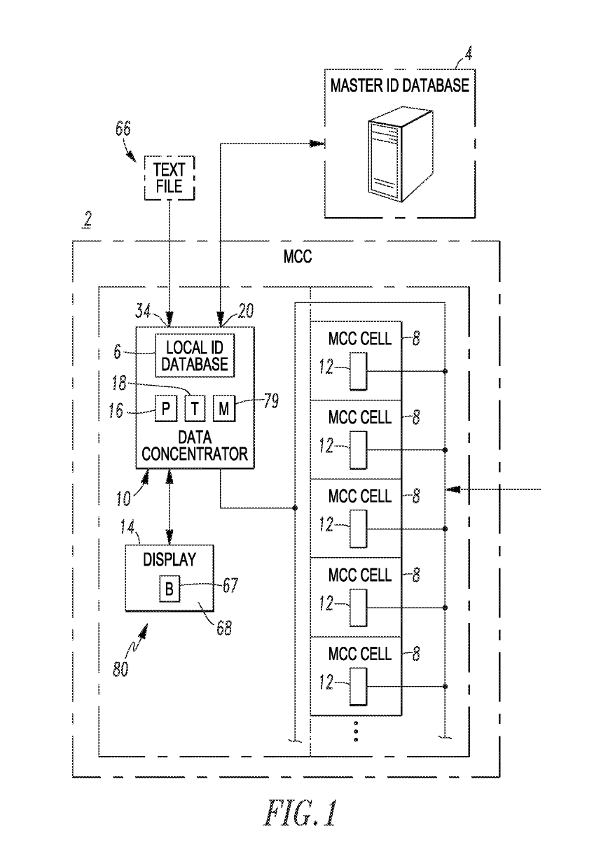

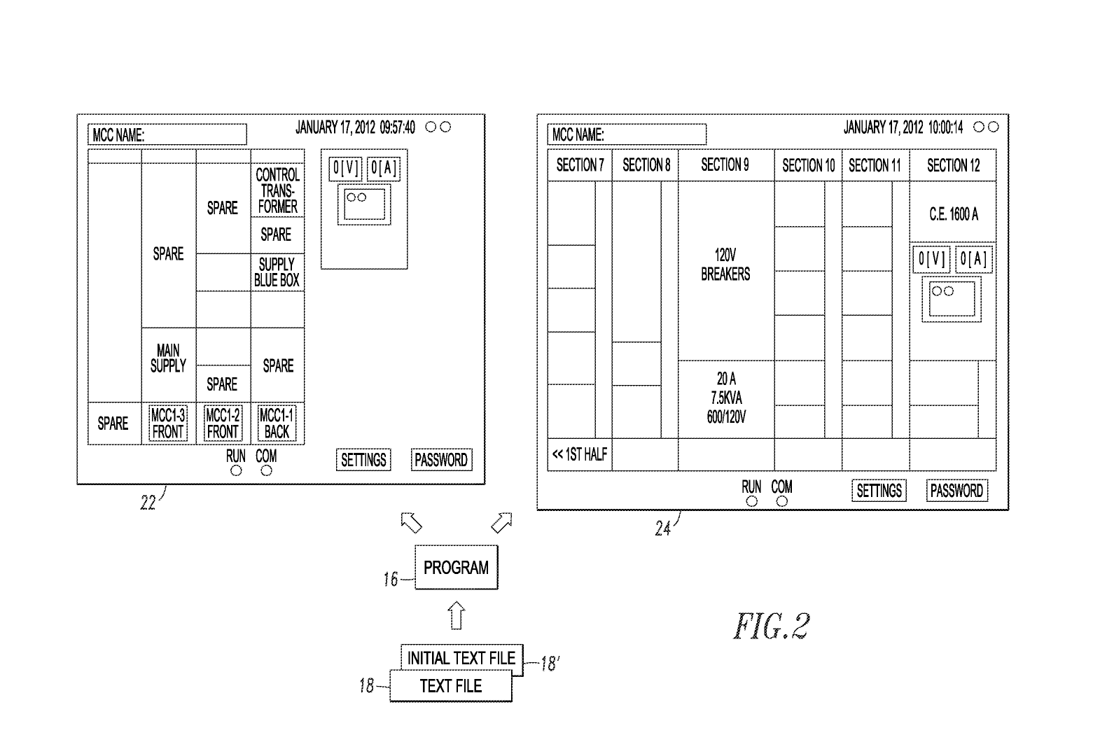

Referring to FIGS. 1 and 2, a system 2 (e.g., without limitation, a motor control center (MCC)) includes a number of databases 4,6, a number of components, such as the example MCC cells 8 (e.g., without limitation, a plurality of motor starters), and a processor, such as the example data concentrator 10. The system 2 automatically configures the MCC cells 8 from one of the databases 4,6 operatively associated with (e.g., without limitation, the database 4 is in communication with the data concentrator 10 of the example system 2; the database 6 is part of the example data concentrator 10 of the system 2) the system 2. The data concentrator 10 includes a display 14, a program (P) 16 and a text file (T) 18. The data concentrator 10 is structured to cause the display 14 to display an initial overview display page 22 operatively associated with the number of MCC cells 8, and is further structured to execute the program 16 and cause the display 14 to display a subsequent overview display page 24 operatively associated with the number of MCC cells 8 based upon the text file 18. The disclosed concept provides a method of display for a number of components, such as the number of MCC cells 8, of the system 2, including displaying the initial overview display page 22 operatively associated with the number of MCC cells 8, and executing the program 16 by the data concentrator 10 and responsively displaying the subsequent overview display page 24 operatively associated with the number of MCC cells 8 based upon the text file 18.

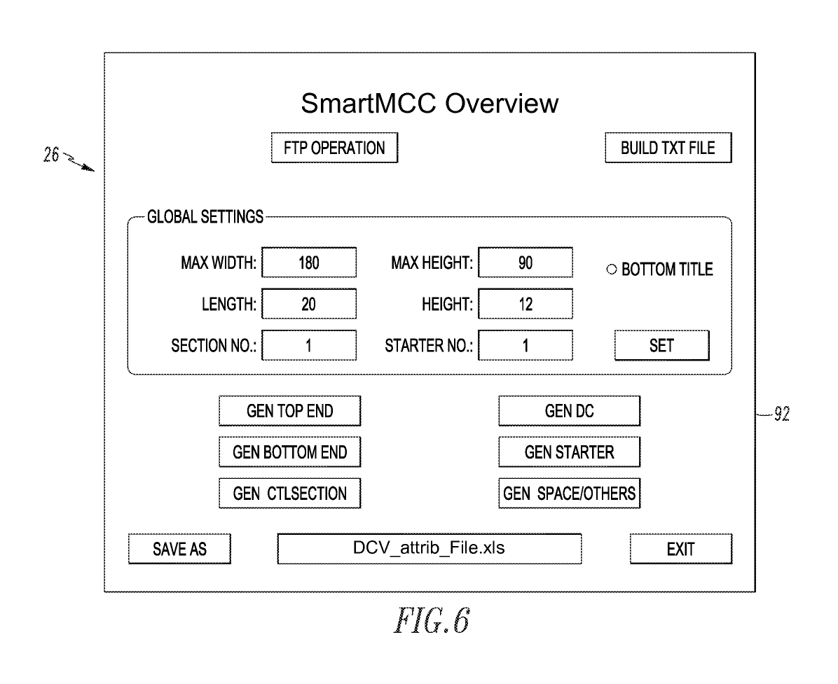

FIG. 2 shows the initial MCC overview default display page 22 that is displayed based upon a text file 18′, the data concentrator runtime program 16, and the subsequent MCC overview display page 24 that is displayed based upon the text file 18, which can be uploaded by the data concentrator 10. The disclosed concept provides the ability to make front layout changes to the MCC overview display pages 22,24 without the need to shut down and re-boot the data concentrator 10. An off-line text editor 26 (FIG. 6) creates a page layout as the text file 18. The runtime program 16 loads the text file 18 and reconfigures the initial MCC overview display page 22, either automatically or by a user initiated command This can handle, for example and without limitation, multiple MCC overview display pages, back-to-back MCCs, relatively large MCCs where scrolling is needed, and permits multiple MCC images to be shown by the one data concentrator 10.

### Example 1

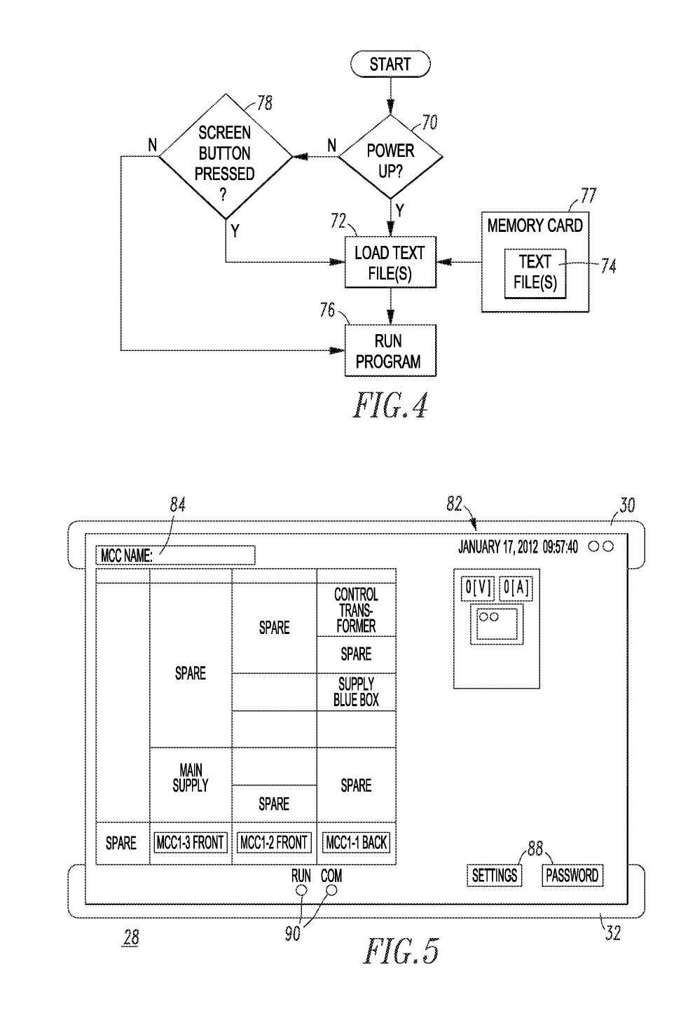

The system 2 is preloaded with a range of MCC overview display pages, such as 28 of FIG. 5, consisting of upper and lower banners 30,32 (FIG. 5). Each overview display page, such as 28, can hold fifty or more predefined cells and seven vertical structures, all of which are sized, by default, as having zero size (i.e., their X and Y dimensions are zero). Each page has a text file, such as 18 of FIG. 2, or multiple pages can share a text file, that provides each element, on the page, with physical data (e.g., visibility; X and Y coordinates; physical size, DX and DY). Based on the size of a human-machine interface (HMI) screen, which is the example data concentrator display 14 (FIG. 1), and the drawing standards for the system 2, a non-limiting example maximum number of vertical structures per page is seven. If more than seven vertical structures are employed, then scrolling is enabled.

The data concentrator 10 is pre-configured such that the initial MCC overview display page 22 (FIG. 2) has all of the available MCC cells 8 populated. Unused cells remain on the overview display page 22, but occupy zero pixels by default. The size and location of each MCC cell of the overview display page 22 is governed by the initial text file 18′, which contains the size and location data for all of the overview page displayed elements. This text file 18′ is read into the data concentrator runtime program 16 on power up of the data concentrator 10 or on demand by a user initialized action. The subsequent text file 18 is generated, off-line, by the text editor 26 (FIG. 6) and the text file 18 is transferred, for example, to the data concentrator 10 over a communication interface 20 (e.g., without limitation, an Ethernet connection) or is uploaded using a memory interface (e.g., without limitation, a USB port 34). The off-line text editor 26 creates the text file 18 based on design criteria (e.g., suitable drawing standards) for the system 2.

The subsequent overview display page 24 includes a plurality of starter cells, and a size and a location of each of the starter cells is defined by the text file 18.

### Example 2

The initial text file 18′ defines the initial overview display page 22 including a plurality of unused cells, and the second text file 18 replaces the first text file 18′. The data concentrator 10 causes the display 14 (FIG. 1) to display the unused cells of the initial overview display page 22 with a size of zero by zero pixels.

### Example 3

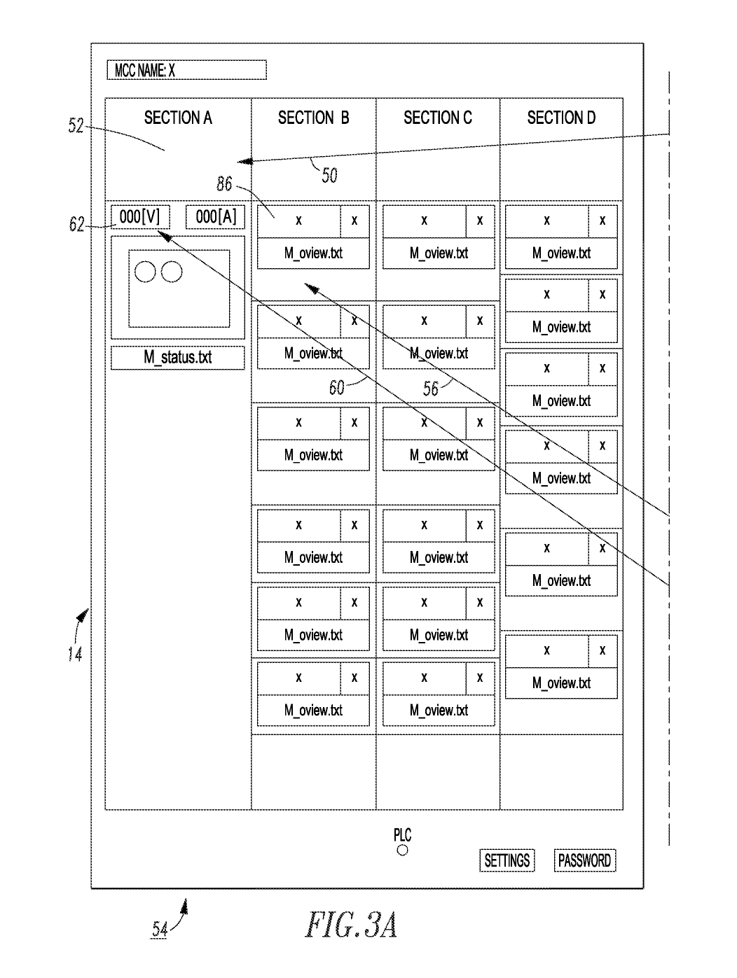

FIG. 3 shows how an example text file 36 corresponds to the data concentrator display 14 by defining visibility (state 38), location (X 40, Y 42) and size (DX 44, DY 46) of various elements (as indexed by #id 48). For the state 38, the value zero means that the corresponding display element is visible and active (e.g., fully functional), and the value one means that the corresponding display element is invisible and inactive (e.g., non-functional), although other suitable state values can be employed (e.g., without limitation, visible and non-functional, which indicates that control exists, but the user does not have the required password level to access it). The value of #id 48 references the entries of the example text file 36 from the runtime program 16 (FIG. 2).

This provides a link, such as 50 for the value of #id 48 of “1” such that the program 16 can find parameters associated with the corresponding screen element 52 of overview display page 54 in the text file 36.

This predefines the displayed elements of the subsequent overview display page 24 (FIG. 2) with the off-line text editor 26, including a plurality of parameters for each of the predefined displayed elements in the text file 18, and defines the parameters of the predefined displayed elements with the off-line text editor 26.

FIG. 3 shows the example relatively simple text file 36 and its corresponding example MCC overview display page 54. For example and without limitation, the link 56 for the value of #id 48 of “27” corresponds to displayed screen element 58, and the link 60 for the value of #id 48 of “31” corresponds to displayed screen element 62. Each of the various links, such as 50,56,60, points to the corresponding displayed screen element, such as 52,58,62, that is defined by the referenced line in the example text file 36. The first line 64 of the example text file 36 has the following properties for the displayed screen element 52 tagged as #id=1 (e.g., a displayed box with “Section A” written on it): the item is visible (state=0), the item is located at screen co-ordinates X=5 and Y=50 (which is the first point of the object), and the item has a size of DX=169 and DY=127 (this is the second point of the object, thereby giving the object a physical size as defined by respective DX and DY distances from the first point).

Other element details, not covered in the example text file 36, are covered in a master file (not shown), which is contained within the compiled code for the data concentrator 10. The example text file 36 is a subset of the master file and provides only a limited amount of information relating to items that can be configured by the user.

### Example 4

The MCC overview text file (MOF) 18 (FIG. 2) is created, off-line, using a suitable (e.g., without limitation, Windows; Visual Basic) text editor 26 (FIG. 6) by the user. The MOF 18 is loaded into the data concentrator 10 (FIG. 1) through one of the communication interface 20 (e.g., without limitation, an Ethernet port) or the memory interface 34 (e.g., without limitation, a USB port using a USB memory device 66). The data concentrator 10 loads the MOF 18 on initial power up or when commanded to do so by a user button (B) 67 on an MCC service page 68 displayed by the display 14. Then, the MCC initial overview display page 22 (FIG. 2) is refreshed to reflect the new layout, which is the example MCC subsequent overview display page 24 (FIG. 2).

### Example 5

Where multiple MCC overview display pages (only one example page 54 is shown in FIG. 3) exist, there are multiple MOF files (only one example text file 36 is shown in FIG. 3), each with a different sequential name (e.g., without limitation, “screen1”; “screen2”; “screen3”).

### Example 6

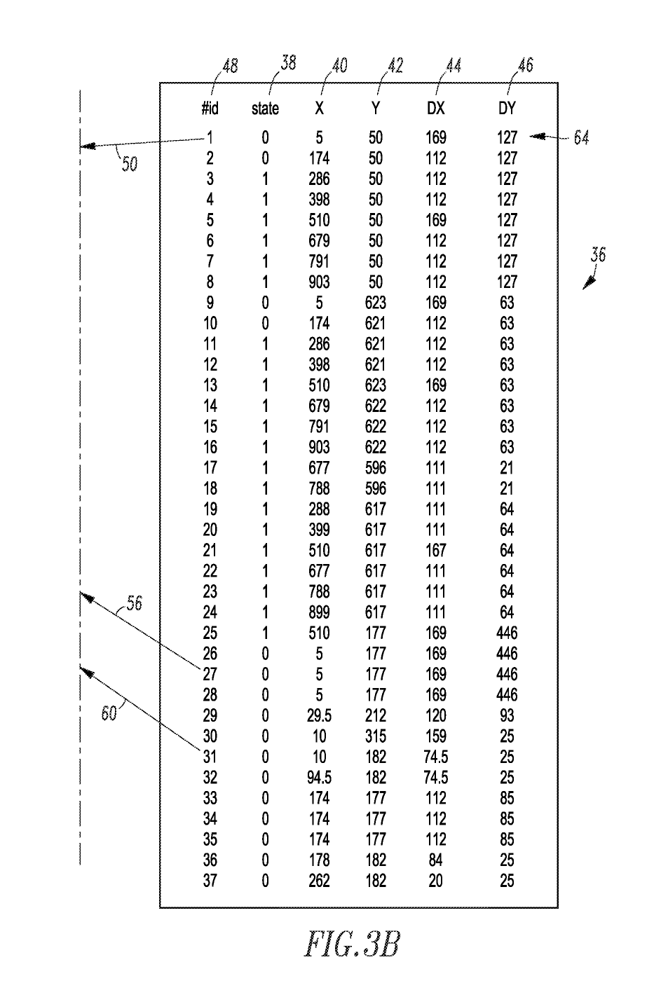

FIG. 4 shows the logic implemented by the data concentrator runtime program 16 of FIG. 2 for loading the MOF 18 or 18′ on initial power up of the data concentrator 10 or when commanded by a user. This refreshes the initial or old MOF 18′ to reflect a new layout based on the subsequent or new MOF 18. The data concentrator 10 can employ any suitable number of multiple MOF files 18 and any corresponding number of overview display screens.

At power up, as determined at 70, a number of text files 74 (only one subsequent text file 18 is shown in FIG. 2) are loaded at 72 and the data concentrator runtime program 16 (FIG. 2) is run at 76. The number of text files 74 can be installed on a suitable memory 77 (e.g., without limitation, USB memory device 66 of FIG. 1; a suitable memory card or device; a removable memory card or device) of the data concentrator 10 by, for example and without limitation: copying directly to the memory 77, downloading over the communication interface 20 through the data concentrator 10, or uploading via a number of memory interfaces 34 on the data concentrator 10 as initiated by a user via the user button 67 from the MCC service page 68 of the data concentrator display 14 (FIG. 1).

If this iteration of the data concentrator runtime program 16, which is run based upon a press of user button 67 by the user or on power up, is not as a result of a power up of the data concentrator 10, and if the user button 67 is pressed, at 78, then the number of text files 74 are loaded at 72 and the runtime program 16 is run at 76. Otherwise, if the user button 67 is not pressed at 78, then the program 16 is run at 76 with any pre-existing number of text files, such as 18′ of FIG. 2.

The data concentrator 10 further includes a suitable user interface 80. In FIG. 4, a load command is executed at 72 responsive to the user interface 80 as tested at 78 or power up of the data concentrator 10 as tested at 70. Responsive to the load command, the data concentrator 10 executes the program 16 at 76, which reads the text file 18, and displays the subsequent overview display page 24 (FIG. 2) based upon the text file 18 (FIG. 2). The data concentrator 10 reads the text file 18 by the program 16 in response to the user interface 80 or on power up of the data concentrator 10, and causes the display 14 (FIG. 1) to display the subsequent overview display page 24 based upon the text file 18.

### Example 7

FIG. 5 shows the example MCC overview display page 28 including the upper and lower banners 30,32 above and below, respectively, various display elements. The top or upper banner 30 contains, for example, a clock 82 and the MCC name 84. The starter names, such as 86 of FIG. 3, appear on the individual cell boxes. The lower banner 32 contains, for example, soft buttons 88 and indicators 90.

### Example 8

FIG. 6 shows a user interface 92 of the text editor 26, which creates the text file 18 (FIG. 2), but not the master file (not shown) that is contained within the data concentrator compiled program 16. The text file 18 is generated using the text editor 26, which allows the user to create the various elements of the MCC overview display page, such as 24 (FIG. 2) or 54 (FIG. 3). The text editor 26 provides predefined elements, the parameters of which are defined by the user. The text editor 26 provides guidance, as to drawing standards, and minimizes user mistakes with regard to these standards by restricting the allowed inputs. The text editor 26 allows for saving of the created text file 18, as a working copy, as well as the text file 18 employed by the system 2. The text editor 26 also permits downloading of the text file 18 (e.g., without limitation, via an Ethernet connection, using an FTP server (not shown) located in the data concentrator 10).

### Example 9

The various components 8 (FIG. 1) can be selected from the group consisting of contactors, relays, motor controllers, disconnects, circuit protective devices, motor starters, switchgear, circuit interrupters, and feeders.

### Example 10

The disclosed concept is described in association with the example system 2 being a motor control center (MCC) and the plurality of MCC cells 8 being smart MCC motor starters, although the disclosed concept is applicable to a wide range of systems having a wide range of any number of suitable components. For example and without limitation, the disclosed concept may find applicability in other power connectivity configurations, adapted or apart from MCCs. A non-limiting example of supply power commonly used in MCCs is 480 V three-phase alternating current (AC) power distributed over three separate supply bus bars. In addition, references to MCC components shall be understood to include the various types of devices and control components which may be housed in a MCC bucket or cell for connection to the supply power. Such devices and components include, for example and without limitation, contactors, relays, motor controllers, disconnects, and circuit protective devices. Alternatively, the system 2 may be switchgear on a custom motor control panel.

### Example 11

As a further non-limiting example, the number of components 8 can include motor starters, switchgear, circuit interrupters, and feeders.

### Example 12

The interface 20 (FIG. 1) can be, for example and without limitation, a global communication network, such as the Internet (e.g., without limitation, via Ethernet). The interface 34 (FIG. 1) can be for a non-volatile memory (e.g., without limitation, a CD; a USB memory device 66).

### Example 13

The module 12 (FIG. 1) can be a smart motor starter module including an input/output (TO) module (not shown).

### Example 14

The system 2 can handle multiple overview display pages, back-to-back MCCs, relatively large MCCs with scrolling, and multiple MCC images shown on the data concentrator display 14. By default, there are four example pages built into the system 2. Text based configuration software, such as the example text editor 26, enables the hidden elements and provides them with their displayable properties.

The text editor 26 generates the text file 18 that is loaded onto the data concentrator memory (M) 79 (FIG. 1). The text file 18 contains the information about page elements including the state of the element (e.g., visible; invisible), the location (its X and Y coordinates) and its size (DX and DY) on the display 14. This also includes, for example and without limitation, elements that enable scrolling, front or back, among other elements.

### Example 15

For example and without limitation, the number of text files 74 reside on the removable memory card 77 (FIG. 4) that resides at or inside the data concentrator 10. When a load command is executed, either on power up or by the user pressing the user button 67, the number of text files 74 are read from the memory card 77 and loaded into the active data concentrator memory (M) 79, from which the runtime program 16 (FIG. 2) is executed. The data concentrator 10 reads the text file(s) 74 from the memory card 77 and loads these text file(s) in the memory 79, and executes the program 16 from the memory 79 and reads the text file 18 from the memory 79.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A system comprising:
a number of components; and
a processor comprising a display, a program and a text file,
wherein said processor is structured to cause said display to display an initial overview display page operatively associated with said number of components, and
wherein said processor is further structured to execute the program and cause said display to display a subsequent overview display page operatively associated with said number of components based upon the text file.

2. The system of claim 1 wherein said processor comprises a removable memory device; and wherein the removable memory device stores the text file.

3. The system of claim 2 wherein said removable memory device is a first memory; wherein said processor further comprises a second memory and a user interface; wherein a load command is executed responsive to said user interface or power up of said processor; wherein responsive to the load command, said processor reads the text file from said removable memory device and loads the text file in said second memory; and wherein said processor executes the program from said second memory and reads the text file from said second memory.

4. The system of claim 1 wherein said processor further comprises a user interface; wherein a load command is executed responsive to said user interface or power up of said processor; and wherein responsive to the load command, said processor executes the program, reads the text file, and displays the subsequent overview display page based upon the text file.

5. The system of claim 1 wherein the text file is a second text file; wherein a first text file defines said initial overview display page including a plurality of unused cells; wherein the second text file replaces the first text file; and wherein said processor is further structured to cause said display to display the unused cells of said initial overview display page with a size of zero by zero pixels.

6. The system of claim 1 wherein said subsequent overview display page includes a plurality of starter cells; and wherein a size and a location of each of said starter cells is defined by the text file.

7. The system of claim 1 wherein said processor further comprises a user interface; and wherein said processor is structured to read the text file by said program in response to said user interface or on power up of said processor, and cause said display to display the subsequent overview display page based upon the text file.

8. The system of claim 1 wherein said subsequent overview display page includes a plurality of displayed elements; wherein each of said displayed elements includes a visibility, a location and a size; and wherein the text file defines the visibility, the location and the size of each of said displayed elements.

9. The system of claim 1 wherein said processor further comprises an interface; and wherein said processor is further structured to receive the text file from said interface.

10. The system of claim 9 wherein said interface is selected from the group consisting of a communication interface and a memory interface.

11. The system of claim 1 wherein said system is a motor control center.

12. The system of claim 11 wherein said number of components are a plurality of motor starters.

13. The system of claim 1 wherein said number of components are selected from the group consisting of contactors, relays, motor controllers, disconnects, circuit protective devices, motor starters, switchgear, circuit interrupters, and feeders.

14. A method of display for a number of components of a system, said method comprising:
displaying an initial overview display page operatively associated with said number of components; and
executing a program by a processor and responsively displaying a subsequent overview display page operatively associated with said number of components based upon a text file.

15. The method of claim 14 further comprising:
creating the text file using an off-line text editor.

16. The method of claim 15 further comprising:
creating the text file with the off-line text editor based on design criteria for the system.

17. The method of claim 15 further comprising:
predefining displayed elements of the subsequent overview display page with the off-line text editor;
including a plurality of parameters for each of the predefined displayed elements in the text file; and
defining the parameters of the predefined displayed elements with the off-line text editor.

18. The method of claim 15 further comprising:
saving a copy of the text file from the off-line text editor.

19. The method of claim 15 further comprising:
downloading a copy of the text file from the off-line text editor using a communication interface.

20. The method of claim 14 further comprising:
displaying a plurality of elements with said subsequent overview display page;
including a visibility, a location and a size for each of said displayed elements; and
defining the visibility, the location and the size of each of said displayed elements from the text file.
